(19) United States
(12) Patent Application Publication
(10) Pub. No.: US 2026/0296195 A1
(43) Pub. Date: Oct. 1, 2026

(54) INDUSTRIAL TRUCK EQUIPPED WITH A POWER FLOW DISPLAY FUNCTION

(71) Applicant: Toyota Material Handling Manufacturing Italy S.p.A., Bologna (IT)

(72) Inventors: Andrea FOLIGNO, Bologna (IT); Nicola PAPPI, Bologna (IT); Daniele IOZZI, Bologna (IT)

(21) Appl. No.: 19/575,725

(22) Filed: Mar. 23, 2026

(30) Foreign Application Priority Data
Mar. 28, 2025 (IT) 102025000006531

(51) Int. Cl. B60K 35/28; B60K 35/10; B60K 35/81; B60W 50/14

(52) U.S. Cl. CPC B60K 35/28; B60K 35/10; B60K 35/81; B60W 50/14; B60K 2360/169; B60W 2050/146; B60W 2300/121; B60W 2510/244; B60W 2540/215

(57) ABSTRACT

An industrial truck comprises: a drive system, a material handling system, an electrical energy storage system which is configured to supply power to the drive system and the material handling system, a user interface comprising a display, and a controller configured to control the drive system, the material handling system, and the display. The controller is configured to determine a plurality of power flows that includes at least one first power flow between the electrical energy storage system and the drive system, and a second power flow between the electrical energy storage system and the material handling system. The controller is further configured to control the display so as to display an indication related to the first power flow and an indication related to the second power flow.

### BACKGROUND

### Technical Field

The present disclosure relates to an industrial truck equipped with a function for displaying a plurality of power flows.

### Description of the Related Art

It is well known in the art to make industrial trucks intended for use in an industrial site, a warehouse, ports, or the like. Forklift trucks are an example of industrial trucks, which typically include a frame, a mast rotatably mounted on the frame, and a fork slidingly mounted on the mast. The fork is used to lift a load, for example to transport goods in a warehouse.

In recent years, electrically powered industrial trucks, which use lithium-ion, lead-acid or other battery systems, have also become widespread.

It is also common to equip the forklift truck with one or more displays to show control information related to the operation of the truck. The display can typically show various types of information, including, for example, the speed of the truck, information related to the position of the fork, and also information related to instantaneous energy consumption, especially in the case of industrial truck of the type powered by electric battery. Conventionally, however, the maximum information available regarding consumption is the instantaneous energy supplied by the battery of the industrial truck.

### BRIEF SUMMARY

Known forklift trucks are not configured to provide the user with much information about machine's energy consumption. In addition to this, there is a complete lack of qualitative/quantitative information for drivers on consumption associated with the various functions of the industrial truck. Overall, these factors result in the driver having limited awareness of the machine's status, lead to suboptimal use of energy by the drivers and to increased costs for truck operations.

It is an object of the present disclosure to provide an electrically powered industrial truck which is able to solve one or more of the problems described above. In particular, an object of the disclosure is to make an industrial truck that is configured to effectively provide the driver with information about the operating status of the industrial truck. A further object is to provide an industrial truck that allows energy consumption to become more effective, thus reducing machine's operating costs.

In view of the above, the present disclosure proposes an industrial truck comprising:
means for moving the industrial truck;
material handling means;
an electrical energy storage system configured to supply power to said means for moving the industrial truck and said material handling means;
a user interface including a display; and
control means configured to control the means for moving the industrial truck, the material handling means, and the display,
wherein the control means are configured to determine a plurality of power flows that includes at least one first power flow between the electrical energy storage system and the means for moving the industrial truck, and a second power flow between the electrical energy storage system and the material handling means,
said control means being further configured to control the display so as to display an indication related to the first power flow and an indication related to the second power flow.

Preferably, the means for moving the industrial truck comprise traction means that are controlled by the control means and that can be powered by said electrical energy storage system,
wherein said plurality of power flows that is determined by the control means includes a power flow between the electrical energy storage system and said traction means,
the control means being further configured to control the display so as to display an indication related to the power flow between the electrical energy storage system and the traction means.

Preferably, the means for moving the industrial truck comprise steering means that are controlled by the control means and that can be powered by said electrical energy storage system,
wherein said plurality of power flows that is determined by the control means includes a power flow between the electrical energy storage system and said steering means,
the control means being further configured to control the display so as to display an indication related to the power flow between the electrical energy storage system and the steering means.

Preferably, the material handling means include lifting means to lift a load that are controlled by the control means and that can be powered by said electrical energy storage system,
wherein said plurality of power flows that is determined by the control means includes a power flow between the electrical energy storage system and the lifting means,
said control means being further configured to control the display so as to display an indication related to the power flow between the electrical energy storage system and the lifting means.

Preferably, the material handling means include means to horizontally translate a load that are controlled by the control means and that can be powered by said electrical energy storage system,
wherein said plurality of power flows that is determined by the control means includes a power flow between the electrical energy storage system and the means for the horizontal translation,
said control means being further configured to control the display so as to display an indication related to the power flow between the electrical energy storage system and the means for the horizontal translation.

Preferably, the material handling means include auxiliary means that are mounted on a mast of the industrial truck for handling a load, said auxiliary means including drives that are powered by the energy storage system,
wherein said plurality of power flows that is determined by the control means includes a power flow between the energy storage system and the auxiliary means,
said control means being further configured to control the display so as to display an indication related to the power flow between the electrical energy storage system and the auxiliary means.

Preferably, the material handling means include tilting means to tilt a mast of the material handling means that are controlled by the control means and that can be powered by said electrical energy storage system,
wherein said plurality of power flows that is determined by the control means includes a power flow between the energy storage system and the tilting means,
said control means being further configured to control the display so as to display an indication related to the power flow between the electrical energy storage system and the tilting means.

Preferably, the control means are configured to associate a color code with an intensity and/or direction of one or more of the said power flows,
said control means being configured to control the display so as to display the indication related to one or more of the said power flows including a color according to the color code that is associated with the respective power flow.

Preferably, the control means are configured to accept a selection input that is entered by the user by means of the user interface to select one or more power flows to display an indication thereof on said display, and to control the display of one or more indications related to the power flows based on the selection input.

Preferably, the means for moving the industrial truck include one or more electric traction motors, the material handling means include a hydraulic pump that is combined with a hydraulic circuit for handling a load, wherein the one or more electric motors and the hydraulic pump can be powered independently of the electrical energy storage system,
wherein each of the indications related to the first power flow and to the second power flow, respectively, includes a quantitative indication of the respective power flow and an indication of the direction of the respective power flow.

Preferably, the control means are configured to control the display so as to display one or more, or all, of a representation of the means for moving the industrial truck, a representation of the material handling means, and a representation of the electrical energy storage system.

Preferably, the control means are configured to control the display so as to display one or more, or all, of a representation of the traction means, a representation of the steering means, a representation of the material lifting means, a representation of the horizontal translation means, a representation of the tilting means, a representation of the auxiliary means that are mounted on a mast of the industrial truck and a representation of the electrical energy storage system.

Preferably, the indication related to a power flow is positioned on the display between the representation of the electrical energy storage system and the representation of the respective means to which the power flow refers.

Preferably, the indication related to a power flow comprises an optical characteristic of a portion of the display in which the representation of the means to which the power flow refers is displayed.

The present disclosure also proposes a method for controlling a display of an industrial truck comprising means for moving the industrial truck, material handling means and an electrical energy storage system which is configured to supply power to said industrial truck moving means and said material handling means, the method comprising:
determining a plurality of power flows that includes at least one first power flow between the electrical energy storage system and the industrial truck moving means, and a second power flow between the electrical energy storage system and the material handling means; and
controlling the display so as to display an indication related to the first power flow and an indication related to the second power flow.

### BRIEF DESCRIPTION OF THE SEVERAL VIEWS OF THE DRAWINGS

The present disclosure will be illustrated with reference to exemplary embodiments described with reference to the accompanying drawings.

In the drawings:

FIG. 1 shows an industrial truck according to the present disclosure;

FIG. 2 schematically shows the main components of the industrial truck of FIG. 1;

FIGS. 3-6 show embodiments of power flow representations according to the present disclosure;

FIG. 7 shows an alternative embodiment of power flow representations according to the present disclosure;

FIG. 8 shows a screen for selecting the power flows to be displayed, and FIG. 9 depicts a display generated according to the selection; and

FIG. 10 shows a possible implementation of the control unit of the industrial truck.

### DETAILED DESCRIPTION

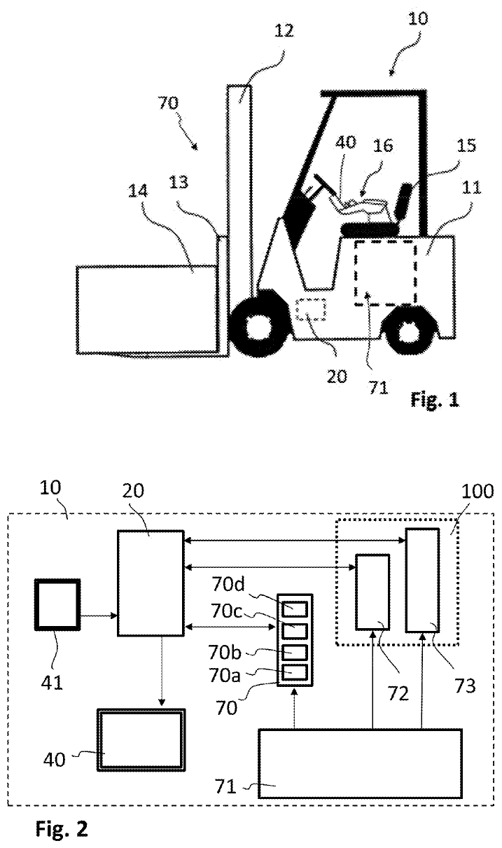

FIG. 1 shows an industrial truck 10 according to an embodiment of the present invention, for example a forklift truck. It is understood that the present disclosure is not limited to a forklift truck, but also includes other industrial trucks intended for use in industrial sites, ports, logistics centers, warehouses or the like.

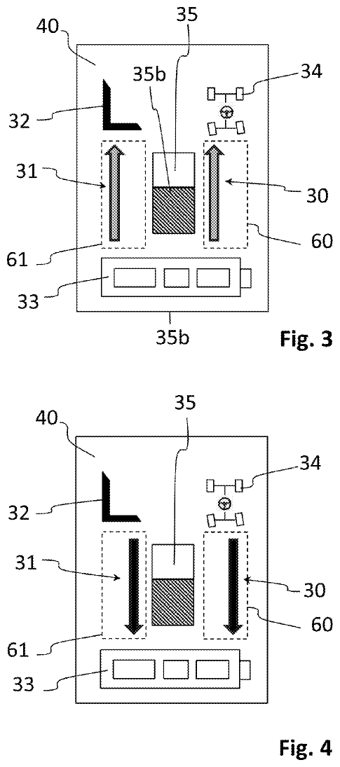

Preferably, the industrial truck includes industrial truck moving means 100 (shown schematically in FIG. 2) and material handling means 70. The industrial truck moving means 100 may comprise traction means 72 and steering means 73 (shown schematically in FIG. 2). In the example shown in the figure, the industrial truck 10 includes a frame 11 and material handling means 70 which include a mast 12 rotatably mounted on the frame 11, and a lifting element 13 (for example a fork) to lift a load 14; the lifting element 13 is mounted on the mast 12 so as to slide along the mast 12; in FIG. 1, the lifting element 13 is shown in a lowered position. It is understood that the material handling means 70 may also be implemented in other ways according to known art. For example, the lifting fork could be replaced with a different handling device, such as a clamp, a ram or the like.

According to an embodiment, the material handling means 70 include lifting means 70a (depicted schematically in FIG. 2). For example, the lifting means include the mast and a fork mounted to slide along the mast.

According to an embodiment, the material handling means 70 include translation means 70b to horizontally translate a load (depicted schematically in FIG. 2). For example, the fork 13 can be mounted on a fork carriage that slides horizontally relative to the mast 12, wherein the means that allow the fork carriage to be translated relative to the mast are part of the horizontal translation means.

In an embodiment, the material handling means 70 include an auxiliary handling device 70c (depicted schematically in FIG. 2), for example, an auxiliary device, such as a clamp, that can be mounted on the mast 12 to replace the fork or auxiliary means for handling sheet material or other devices with movable parts for engaging a load. The auxiliary device 70c (also referred to in this disclosure as “auxiliary means” or “auxiliary material-handling means”) may include drives powered by the energy storage system 71 of the industrial truck, which will be described below.

In an embodiment, the material handling means 70 include tilting means 70d (shown schematically in FIG. 2) that allow a mast 12 of the handling means to be tilted. These tilting means allow the mast to be tilted within a range of positions that comprises a vertical position of the mast, for example around a horizontal axis positioned near the front axle of the industrial truck.

In an embodiment, the material handling means 70 include all of the tilting means 70d, the lifting means 70a, the horizontal translation means 70c, and the auxiliary means 70d mounted on the mast. Preferably, the material handling means 70 are powered by the energy storage system 71 (FIG. 2). According to known art, the material handling means 70 may include a hydraulic pump that feeds hydraulic drives intended to move the movable parts of the material handling means. Other types of drives are also possible and the present disclosure is not limited to a specific implementation of the drives. In an embodiment, the same hydraulic pump can supply oil to the drives of the lifting system 70a, the load horizontal-translation system 70b, and the auxiliary device 70c to be mounted on the mast of the industrial truck. Alternatively, several independent hydraulic circuits can be provided.

The industrial truck 10 preferably comprises a user station, for example in the form of a user seat 15. The station can be made in a driver's cabin. The seat 15 can be accommodated in the cabin. The seat may advantageously include an armrest 16 on a seat side. In a preferred embodiment, a display 40 of the industrial truck 10 may be mounted on the armrest 16, for example at an end thereof. However, other configurations are also possible; the present disclosure also covers mounting the display 40 on the industrial truck 10 at other positions, for example on the dashboard or even other positions visible to the operator in the driver's station.

The industrial truck 10 can preferably be electrically powered by means of an electrical energy storage system 71 shown in dotted lines in FIG. 1. The electrical energy storage system 71 can be housed, for example, inside the frame 11, either in a removable or integrated and non-removable manner. For example, the electrical energy storage system 71 may be arranged at least partially below the driver's station. The electrical energy storage system 71 may include any battery system, for example one or more battery packs, which may be of lithium-ion or even lead-acid, nickel-metal hydride, or any other known type. Alternatively, the industrial truck could also include an internal combustion engine, or it could include a hybrid drive system, thus equipped with one or more electric and internal combustion engines.

The industrial truck 10 may include four wheels or three wheels arranged on a front axle and a rear axle. The industrial truck may include a steering wheel for steering the truck while driving, for example, for steering the front wheels and/or the rear wheels of the truck. However, other multi-axle configurations are also included in the present disclosure. Similarly, other means of issuing driving commands to the industrial truck may also be used in addition to or in place of the steering wheel, for example a joystick or the like.

The industrial truck 10 includes traction means 72 (shown schematically in FIG. 2) intended to enable the truck itself to move. The traction means 72 preferably include one or more electric motors, for example one electric motor for each axle of the industrial truck. Preferably, the traction means 72 are powered by the energy storage system 71, as schematically shown in FIG. 2.

The industrial truck 10 further comprises a steering system 73 (also referred to as steering means in the present disclosure and shown schematically in FIG. 2) that can be powered by said electrical energy storage system 71. Preferably, the steering system 73 comprises one or more electric steering motors (not shown) which are configured to control the steering of the wheels of the industrial truck, said electric steering motors being able to be powered by the electrical energy storage system 71 independently of the traction means 72 and the material handling means 70. The steering system may comprise, for example, an electric power steering or another known type of steering.

The industrial truck 10 further includes a control unit 20 (shown schematically by dotted lines in FIG. 1 and by solid lines in the diagram in FIG. 2) configured to control the material handling means 70 and the locomotion means 100. In the present disclosure, the control unit 20 may be referred to as “controller 20” or “control means 20”, which should be understood as synonymous. Preferably, the control unit 20 is configured to control the material handling means 70 and/or the traction means 72, and/or the steering means 73 based on commands issued by a user of the machine via a user interface. The user interface (denoted schematically by the reference numeral 41 in FIG. 2) may include a steering wheel, a touchscreen, a keypad, a joystick, one or more pedals, or other command input interfaces or a combination thereof. The control unit 20 may be implemented in any known manner, for example, by means of a processing device, an electronic board, or one or more processing devices. The control unit according to the present disclosure is not limited to any type of hardware and/or software implementation, and may be implemented by a distributed architecture or a single device. As shown in FIG. 2, the control unit 20 is connected to the display 40 and is configured to control the display 40 and its operating modes. In an embodiment, the display 40 could be implemented by a touchscreen. In this case, the display 40 could also be part of the input interface of the industrial truck (or more generally of the user interface 41) and could be configured to receive input from the truck user via a tactile input.

In an embodiment, the control means 20 are configured to determine a plurality of power flows output from and input to the energy storage system 71. For example, the plurality of power flows determined by the control means 20 include at least:
one first power flow between the electrical energy storage system 71 and the moving means 100; and
one second power flow between the electrical energy storage system 71 and the material handling means 70.

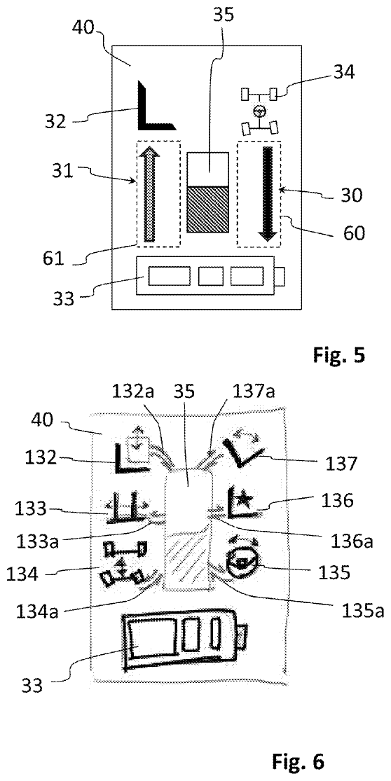

As shown in FIGS. 3-5, the control means 20 are configured to control the display 40 so as to display an indication related to the first power flow 30 and an indication related to the second power flow 31. The first and second flows can be displayed simultaneously if both the power flows are simultaneously non-zero. In the absence of a power flow, according to an embodiment, no indication is displayed.

Preferably, the display 40 is controlled to display a representation of the material handling means 32, a representation of the truck moving means 34, and a representation of the energy storage system 33. In an embodiment, the representation of the material handling means 32 and the representation of the truck moving means 34 may be in the form of icons. A dedicated area 61 is formed on the display 40, between the representation of the material handling means 32 and the representation of the energy storage system 33, for displaying the indication related to the second power flow 31. A dedicated area 60 is formed on the display 40, between the representation of the truck moving means 34 and the representation of the energy storage system 33, for displaying the indication related to the first power flow 30.

In a preferred embodiment, the control means 20 are configured to control the display so as to simultaneously display a representation of the industrial truck moving means 34, a representation of the material handling means 32, and a representation of the electrical energy storage system 33, wherein said indication related to the first flow 30 is positioned on the display between the representation of the electrical energy storage system 33 and the representation of the moving means 34, while the indication related to the second flow 31 is positioned on the display between the representation of the electrical energy storage system 33 and the representation of the material handling means 32. This arrangement provides the user with a compact and effective indication of a plurality of power flows affecting different systems of the industrial truck.

The indication of the first and second power flows 30, 31 may be in the form of an arrow. The direction of the arrow indicates the direction of the power flow, which may vary, for example, when power is supplied from the energy storage system or in case of recharging, when power flows from the utility grid to the battery. The arrow 30, 31 may have a color associated with flow intensity, or a length associated with the flow magnitude. In an embodiment, the display 40 is controlled to display a magnitude 35 of the flow related to instantaneous power. The magnitude of the flow can be displayed by a column 35b whose length corresponds to the magnitude of the power. The arrow 30, 31 could also be replaced by a bar, where the direction of the flow can be indicated by a color code.

FIG. 3 shows the situation in which the energy storage system supplies power to the material handling means 70 and the moving means 100. FIG. 4 shows the case in which the energy storage system 71 is recharged and absorbs power from the material handling means and the moving means, for example when a load is lowered by the forks of the truck and the industrial truck is braking. FIG. 5 shows the case in which the material handling means 70 absorb energy, for example when lifting a load, and the moving means send energy to the battery (regeneration), for example when braking.

Preferably, the means for moving the truck 100 include one or more electric traction motors, and the material handling means 70 include a hydraulic pump that is combined with a hydraulic circuit for handling a load; the one or more electric motors and the hydraulic pump can be powered independently of the electrical energy storage system 71. In this case, quantitative indication of both the first and second power flows affecting the truck moving means and the material handling means, respectively, can be obtained by means of appropriate power sensors. Therefore, each of the indications related to the first power flow and the second power flow, respectively, may include a quantitative indication of the respective power flow and/or an indication 31, 32 of the direction of the respective power flow. This quantitative indication can be displayed, for example, by the bar 35. The bar 35 can be advantageously positioned between the dedicated area 61 and the dedicated area 60.

Preferably, as set forth above, the material handling means 70 include load lifting means 70a (or lifting system 70a) that are controlled by the control means 20 and that can be powered by said electrical energy storage system 71. In this case, the plurality of power flows determined by the control means 20 may preferably include a power flow between the electrical energy storage system 71 and the lifting system (or means) 70a. Preferably, the control means 20 may be configured to control the display 40 so as to display an indication related to the power flow between the electrical energy storage system 71 and the lifting system 70a simultaneously with the indications 30, 31 related to the first and second power flows, or, alternatively, so as to replace the indication related to the power flow between the energy storage system and the material handling means.

In the embodiments where the material handling means 70 include horizontal translation means 70b (or horizontal translation system 70b) for a load, which are controlled by the control means 20 and which can be powered by said electrical energy storage system 71, said plurality of power flows which is determined by the control means 20 may advantageously also include a power flow between the electrical energy storage system 71 and the horizontal translation system 70b. In this case, the control means 20 are configured to control the display 40 so as to display an indication related to the power flow between the energy storage system 71 and the horizontal translation system 70b.

In the embodiments where the material handling means 70 include a device 70c mounted on a mast of the industrial truck (such as a clamp or other auxiliary gripping device), the plurality of power flows determined by the control means 20 may include a power flow between the energy storage system 71 and the auxiliary device 70c. In this case, the control means may be configured to control the display 40 so as to display an indication related to the power flow between the energy storage system 71 and the auxiliary device 70c.

In the embodiments where the material handling means 70 include tilting means 70d to tilt the mast, the plurality of power flows determined by the control means 20 may include a power flow between the energy storage system 71 and the tilting means 70d. In this case, the control means may be configured to control the display 40 so as to display an indication related to the power flow between the energy storage system 71 and the tilting means 70d.

In the example shown in FIGS. 3-5, the display 40 displays a representation 32 of the material handling means 70 and a representation 34 of the moving means 100. In the example shown in FIG. 6, the display displays a representation 132 of the lifting means 70a, a representation 133 of the horizontal translation means 70b, a representation 134 of the traction means 72, a representation 135 of the steering means 73, a representation 136 of the auxiliary means 70c, a representation 137 of the tilting means 70d, and a representation 33 of the energy storage system.

FIG. 6 shows the display 40 displaying:
the indication 132a related to the power flow between the energy storage system 71 and the lifting means 70;
the indication 133a related to the power flow between the energy storage system 71 and the horizontal translation means 70b;
the indication 134a related to the power flow between the energy storage system 71 and the traction means 72;
the indication 135a related to the power flow between the energy storage system 71 and the steering means 73;
the indication 136a related to the power flow between the energy storage system 71 and the auxiliary material-handling means which are mounted on the mast 70c; and
the indication 137a related to the power flow between the energy storage system 71 and the tilting means 70d.

In a preferred embodiment, the indication related to a power flow is positioned on the display between the representation of the electrical energy storage system and the representation of the respective means to which the power flow refers. An example of such an embodiment is shown in FIGS. 3-6. For example, in such a case, the indication may include an arrow. The arrow may have a color associated with the direction of flow (regeneration or consumption).

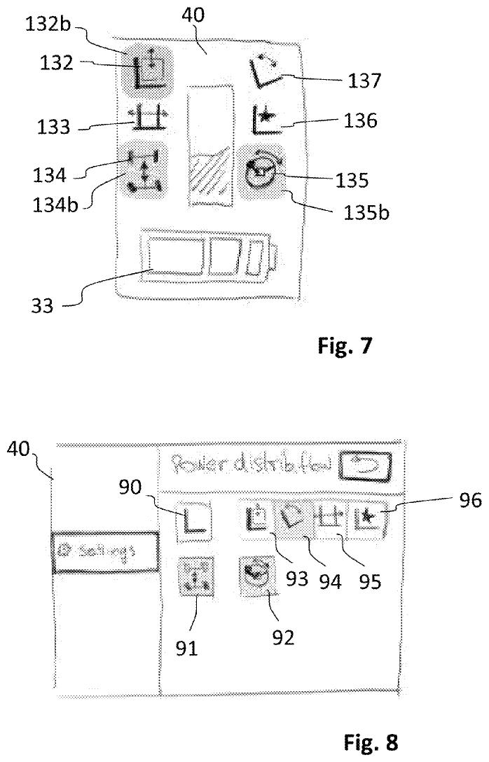

According to an alternative embodiment, the indication related to a power flow comprises an optical characteristic of a portion of the display in which the representation of the means to which the power flow refers is displayed. For example, as shown in FIG. 7, the indication related to a power flow comprises a characteristic of a background on which the representation of the means to which the power flow refers is depicted, for example, the background of an icon that is part of the representation of the means. In FIG. 7, representations 132-137 are similar to representations 132-137 in FIG. 6. However, indications 132a-137a are replaced by optical characteristics 132b, 135b or 135b of the portion of the display which displays the representation. For example, the optical characteristic could be a color, or even an outline or hatching. In the case of a color, for example, a color code can be associated with a characteristic of the power flow. For example, if the power flow is of regenerative type, the color green can be used in zone 132b, whereas if the power flow is energy consumption, the color red can be used in zone 134b. According to this embodiment, information related to the power flows of many loads may be provided in compact and clear manner, while taking into account that the space on the display is still limited.

In general, the control means 20 may be configured to associate a color code with an intensity and/or direction of one or more of the above-described power flows. The control means are configured to control the display 40 so as to display the indication related to one or more of the power flows by including a color according to the color code that is associated with the respective power flow.

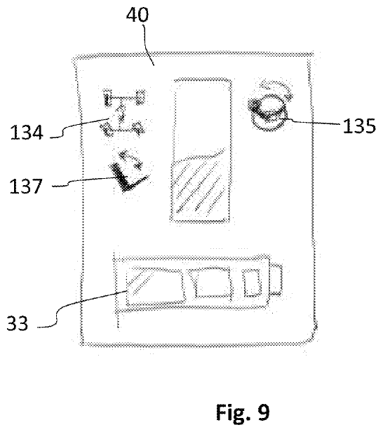

With reference to FIG. 8, an embodiment is shown in which the control means are configured to accept a selection input entered by the user via the user interface 41 to select one or more power flows, a selection of which is to be displayed on said display 40. For example, the selection input can be entered via a tactile input if the user interface 41 consists of a touchscreen, which may correspond to the display 40 discussed above, or may be a different display. In this case, as shown in FIG. 8, multiple icons 90-96 can be shown on the display 40, which correspond to multiple means 70, 100, 70a, 70b, 70c, 70d, 72, or 73, which can be selected to be displayed. Each icon can be associated with one of the systems (or means) described above, such as traction means, material handling means, industrial truck moving means, translation means, lifting means, steering means, tilting means or auxiliary handling means. Preferably, the icons 90-96 correspond graphically to the representations of the means 132-137, which are displayed together with the indications related to the flows. By tapping or otherwise selecting an icon, the corresponding means is selected. In the example shown in FIG. 8, the traction means are selected through the icon 91, the steering means through the icon 92 and the tilting means through the icon 94. As a result, during use, the display 40 shows the representations 134, 137, and 135 of the traction means, the tilting means and the steering means, as shown in FIG. 9.

In the examples discussed above, the representation of the power flow indication may preferably refer to an instantaneous power flow. The various power flows can be determined by the control means 20 of the industrial truck in various ways according to known art, for example by means of appropriate sensors or power measuring devices suitably applied to the power supply lines of the various systems of the truck, or even according to commands issued by the user via the control means and the user interface to control the operations of the industrial truck.

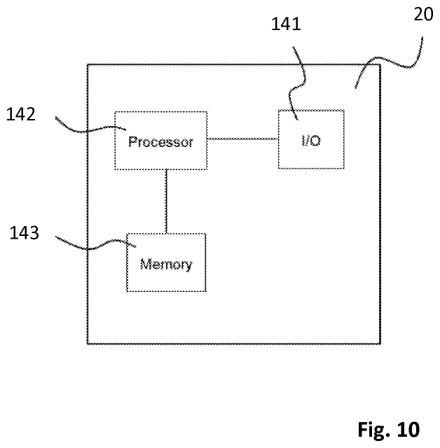

FIG. 10 shows a possible implementation of the control unit 20. In an embodiment, the control unit 20 includes a processor 142, a memory 143 and a I/O interface 141. The processor is configured to execute a control software stored on the memory 143 to execute any of the functions of the control unit 20 as above described. When executing the control software, the processor 142 may receive as input information from one or more sensors and/or units of the industrial truck by means of the I/O interface 141; the processor 142 may further output control signals to the display 40 and/or to one or actuators of the industrial truck using the I/O interface 141 as well. Also other possible implementations of the control unit can be conceived, e.g., including a plurality of distributed processors or the like.

Thanks to the present disclosure, an industrial truck equipped with an improved display function to effectively and compactly provide information on the operating status of the machine can be provided. This allows driving to be made easier for the user, who can monitor vehicle's energy consumption more accurately and immediately. Feedback on the condition of the vehicle can be provided to the user in real time, thus also enabling control and optimization of the driving style and leading to reduced energy consumption.

1. An industrial truck including:
a drive system configured to move the industrial truck;
a material handling system;
an electrical energy storage system configured to supply power to the drive system and the material handling system;
a user interface including a display; and
a controller configured to control the drive system, the material handling system, and the display,
wherein the controller is configured to determine a plurality of power flows that includes at least a first power flow between the electrical energy storage system and the drive system, and a second power flow between the electrical energy storage system and the material handling system,
the controller being further configured to control the display so as to display an indication related to the first power flow and an indication related to the second power flow,
wherein the controller is configured to accept a selection input that is entered by a user via the user interface to select one or more power flows to display an indication thereof on the display, and to control the displaying of one or more indications related to the power flows based on the selection input.

2. The industrial truck according to claim 1, wherein the drive system includes a traction system that is controlled by the controller and that can be powered by the electrical energy storage system,
wherein the plurality of power flows that is determined by the controller includes a power flow between the electrical energy storage system and the traction system,
the controller being further configured to control the display so as to display an indication related to the power flow between the electrical energy storage system and the traction system.

3. The industrial truck according to claim 1, wherein the drive system includes a steering system that is controlled by the controller and that can be powered by the electrical energy storage system,
wherein the plurality of power flows that is determined by the controller includes a power flow between the electrical energy storage system and the steering system,
the controller being further configured to control the display so as to display an indication related to the power flow between the electrical energy storage system and the steering system.

4. The industrial truck according to claim 1, wherein the material handling system includes a lifting system for lifting a load that is controlled by the controller and that can be powered by the electrical energy storage system,
wherein the plurality of power flows that is determined by the controller includes a power flow between the electrical energy storage system and the lifting system,
the controller being further configured to control the display so as to display an indication related to the power flow between the electrical energy storage system and the lifting system.

5. The industrial truck according to claim 1, wherein the material handling system includes a horizontal translation system for horizontally translating a load that is controlled by the controller and that can be powered by the electrical energy storage system,
wherein the plurality of power flows that is determined by the controller includes a power flow between the electrical energy storage system and the horizontal translation system,
the controller being further configured to control the display so as to display an indication related to the power flow between the electrical energy storage system and the horizontal translation system.

6. The industrial truck according to claim 1, wherein the material handling system includes an auxiliary handling device that is mounted on a mast of the industrial truck for handling a load, the auxiliary handling device including drives that are powered by the electrical energy storage system,
wherein the plurality of power flows that is determined by the controller includes a power flow between the electrical energy storage system and the auxiliary handling device,
the controller being further configured to control the display so as to display an indication related to the power flow between the electrical energy storage system and the auxiliary handling device.

7. The industrial truck according to claim 1, wherein the material handling system includes a tilting system for tilting a mast of the material handling system that is controlled by the controller and that can be powered by the electrical energy storage system,
wherein the plurality of power flows that is determined by the controller includes a power flow between the electrical energy storage system and the tilting system,
the controller being further configured to control the display so as to display an indication related to the power flow between the electrical energy storage system and the tilting system.

8. The industrial truck according to claim 1, wherein the controller is configured to associate a color code with an intensity and/or direction of one or more of the power flows,
the controller being configured to control the display so as to display the indication related to one or more of the power flows by including a color according to the color code that is associated with the respective power flow.

9. The industrial truck according to claim 1, wherein the drive system includes one or more electric traction motors, the material handling system includes a hydraulic pump that is associated with a hydraulic circuit for the handling of a load, wherein the one or more electric traction motors and the hydraulic pump can be powered independently of the electrical energy storage system,
wherein each of the indications related to the first power flow and to the second power flow includes a quantitative indication of the respective power flow and an indication of a direction of the respective power flow, respectively.

10. The industrial truck according to claim 1, wherein the controller is configured to control the display so as to display one or more, or all, of a representation of the drive system, a representation of the material handling system, and a representation of the electrical energy storage system.

11. The industrial truck according to claim 1, wherein the controller is configured to control the display so as to display one or more, or all, of a representation of a traction system, a representation of a steering system, a representation of a lifting system, a representation of a horizontal translation system, a representation of a tilting system, a representation of a auxiliary handling device that is mounted on a mast of the industrial truck and a representation of the electrical energy storage system.

12. The industrial truck according to claim 10,
wherein the indication related to a power flow is positioned on the display between the representation of the electrical energy storage system and the representation of the respective system or device to which the power flow is referring.

13. The industrial truck according to claim 10,
wherein the indication related to a power flow includes an optical characteristic of a portion of the display in which it is displayed the representation of the system or device to which the power flow is referring.
